(19) United States
(12) Patent Application Publication
(10) Pub. No.: US 2006/0011228 A1
(43) Pub. Date: Jan. 19, 2006

(54) Mobile Medical Support Device

(76) Inventor: H. Randall Craig, Chandler, AZ (US)

Correspondence Address: OPPEDAHL AND LARSON LLP, P O BOX 5068, DILLON, CO, 80435-5068, US

(21) Appl. No.: 11/163,311

(22) Filed: Oct. 13, 2005

Related U.S. Application Data
(60) Provisional application No. 60/594,667, filed on Apr. 27, 2005.

(51) Int. Cl. A47B 37/00; A61H 3/00

(52) U.S. Cl. 135/67; 108/50.16

(57) ABSTRACT

The invention increases the mobility of patients who suffer from medical conditions that are characterized by very heavy tissue weight extending from the front of the body. These medical conditions include gigantomastia, large abdominal pannus, large abdominal tumors, and high multiple pregnancy. Mobility in these patients is generally severely restricted, and in some cases the patients are confined to wheelchairs or are bedridden. The device can be used in these cases to provide a relatively normal mobility around the home, hospital, or any ADA surface. One embodiment of the invention is a support frame which transmits tissue weight to the ground, and is comprised of five basic components—rolling wheels, a support frame, a lifting mechanism, a tissue support platform, and a brassiere or tissue sling.

### CROSS-REFERENCE TO RELATED APPLICATIONS

This application claims the benefit of U.S. Application No. 60/594,667 filed Apr. 27, 2005 which is hereby incorporated herein by reference for all purposes.

### BACKGROUND

A large number of medical assist devices are currently manufactured to improve the mobility of patients with certain physical disabilities. In addition to wheelchairs, these devices include frame “walkers,” canes and crutches, rolling seats, and lift walkers. Patients who have difficulty standing or walking routinely use these devices to improve their mobility and self sufficiency. A large variety of these devices are currently on the market to assist patient's with generalized muscle weakness, arthritis weight bearing pain, or morbid obesity. Most currently available mobility assisting devices are designed to carry excess weight where the center of gravity lies approximately over the central axis of the skeleton or over the patient's legs.

Several medical syndromes cause development of excess weight on the anterior portion of the body. Most of these syndromes can be classified into four basic medical categories:

(1) Gigantomastia—Characterized by overdevelopment of the breasts in women. The average adult breast weight ranges from 150 grams to 850 grams each, but women with gigantomastia may have breast weight ranging from 7,000 grams to 40,000 grams or more. Overgrowth of breast tissue is usually due to an excessive tissue response to normal circulating hormone levels, with the medical diagnosis of gigantomastia, categorized into three major groups. The first group is adolescent mammary hyperplasia, which is characterized by rapid uncontrolled breast growth at the time of puberty, which often responds to tamoxifen therapy. The second group is gestational mammary hypertrophy characterized by massive breast enlargement during pregnancy, usually followed by return of breasts to baseline size during the postpartum period. The third category is drug-induced breast hypertrophy generally presenting as massive breast growth as a rare side effect in women taking penicillamine, Neothetazone, cyclosporin, or reverse transcriptase inhibitors for the treatment of HIV. A final subcategory is the diagnosis of gigantopolymastia, where massive enlargement occurs in four or more breasts, with additional breasts generally developing in pairs in the axillary region above the natural set, or immediately below the natural set. In cases of severe gigantomastia, total breast weight can exceed 50 kilograms, with the patient unable to stand or walk because of this disability.

(2) Large abdominal pannus—Generally seen in massively obese patients who undergo significant weight loss, usually after gastric bypass surgery. The rest of the body loses weight in a relatively even fashion, but the anterior abdomen remains disproportionally enlarged with a large amount of lower abdominal tissue (pannus) handing down to the thighs or even below the knees. The large amount of low-hanging weight makes standing and walking very difficult, and excessive redundant skin folds collect moisture which results in frequent skin infections and a chronic hygiene problem.

(3) Large abdominal tumor—Typically an ovarian mucinous cystadenoma or large leiomyoma. These benign growths can develop into the largest tumors known in the human body, with the ovarian tumors reaching over 150 kilograms in severe cases. Generally, the rest of the body is not enlarged, and can sometimes become anorexic because of the loss of nutrition to the metabolic demands of the tumor. These patients are also unable to stand or walk due to the extreme weight and the far anterior and inferior position at the center of gravity of the tumor.

(4) High multiple pregnancy—Typically quadruplets, quintuplets, and sextuplets or more. The abdominal distention with high multiple pregnancy during the third trimester can become extreme, and the combined weight of several fetuses, placenta, amniotic fluid, and uterine support structures can exceed 30 kilograms. Women with high multiple pregnancy are often bedridden during the second and third trimester due to the large amount of anterior offset weight, and because of reduced mobility they are more prone to the development of blood clots and pulmonary embolism.

In general, each of these syndromes is a temporary condition. The great majority of patients do not tolerate the excess weight generated by these syndromes for long periods of time, and typically obtain medical or surgical relief. Patients with gigantomastia will usually have reduction mammoplasty or mastectomy procedures, or will await natural resolution during the postpartum period. Plastic reduction procedures are also available for large abdominal panus, and surgical removal of large ovarian tumors or leiomyomas is done once patients become immobilized by excessive abdominal weight. High multiple pregnancy weight is self-correcting at the time of delivery of the pregnancy. For most patients, the period of disability ranges from six weeks to six months before medical or surgical relief is achieved. However, during this period of time they suffer from true significant physical disability, and would greatly benefit from a medical mobility device designed to support excess frontal body weight until medical or surgical corrective measures can be taken.

Therefore, there is a need and desire for a mobility assisting device for the subset of patients who suffer from medical conditions and disabilities related to excessive weight extending from the front (anterior) of the body. Patients who have excess body weight with the center of gravity located far anterior to the skeletal axis, requiring a support mechanism which is designed to relieve the muscle and skeletal system of a patient's offset weight could greatly benefit from a mobility assisting device.

### SUMMARY OF THE INVENTION

The device of the invention is designed to increase the mobility of patients who suffer from medical conditions that are characterized by very heavy tissue weight extending from the front of the body, with the center of the gravity of the tissue significantly offset from the skeletal axis. These medical conditions include gigantomastia, large abdominal pannus, large abdominal tumors, and high multiple pregnancy. Mobility in these patients is generally severely restricted, and in some cases the patients are confined to wheelchairs or are bedridden. The device can be used in these cases to provide a relatively normal mobility around the home, hospital, or any ADA surface.

One embodiment of the invention is a support frame which transmits tissue weight to the ground, and is comprised of five basic components—rolling wheels, a support frame, a mechanical lifting mechanism, a tissue support platform, and a brassiere or tissue sling. Embodiments of the invention provide three primary functions:
(1) Support of heavy frontal tissue, with the weight of the tissue transmitted to the ground;
(2) Raising and lowering of heavy tissue to two primary positions, sitting and standing/ambulation, which minimizes skin and connective tissue stretching by holding the center of gravity at the same relative chest or abdominal level for each position;
(3) Rolling mobility which allows free movement of the patient to accomplish routine daily tasks.

Several variations of each of the five components are further described in the detailed description below, and these variations can be mixed and matched together into a customized rolling medical support device, depending upon the specific requirements of individual patients.

### BREIF DESCRIPTION OF THE DRAWINGS

The invention will be described with respect to a drawing in several figures.

FIG. 1A illustrates an embodiment of the invention where the user is in a sitting position.

FIG. 1B illustrates an embodiment of the invention where the user is in a standing or walking position.

FIG. 2 is an overview of one embodiment of the system of the invention.

FIGS. 3A-H illustrate several embodiments of the frame of the invention.

FIGS. 4A-F illustrate several embodiments of the wheels of the invention.

FIGS. 5A-G illustrate several embodiments of mechanical lifting mechanisms of the invention.

FIGS. 6A-F illustrate several embodiments of platforms of the invention.

FIGS. 7A-E illustrate several embodiments of brassieres or slings of the invention.

FIG. 8 illustrates an embodiment of the invention where there are two support platforms and two slings.

FIG. 9 illustrates a front view of an embodiment of the invention where there are two support platforms and two slings.

FIG. 10 illustrates a front view of an embodiment of the invention where there are two support platforms and two slings positioned at different heights.

FIG. 11 illustrates a front view of an embodiment of the invention having two suspended slings.

FIG. 12 illustrates a front view of an embodiment of the invention having two suspended slings positioned at different heights.

### DETAILED DESCRIPTION

General Overview

One embodiment of the invention is a rolling medical device designed to support a large amount of anterior body weight which satisfies a number of basic physical and medical requirements, including:
(1) Capacity to support up to 100 pounds for gigantomastia or high multiple pregnancy, up to 150 pounds for large abdominal panus, and up to 300 pounds for large abdominal tumors.
(2) Stability on standard ADA surfaces.
(3) Relatively lightweight.
(4) Easily portable, and fits in the backseat or trunk of a sedan automobile.
(5) Large enough wheels for smooth rolling, but small enough to avoid wall jams.
(6) Physically stable and not easily tipped over.
(7) Accommodate standard patient heights ranging from 58 inches to 78 inches.
(8) Sufficient internal leg room to permit standard walking stride without the legs or feet hitting the frame.
(9) Sufficient space in the frame to allow the patient to sit in an armless chair without the legs or knees striking the frame, and able to accommodate the enlarged abdomen of a pregnant patient in standing or sitting position.
(10) Sufficient internal space to allow the patient to sit on a standard size or handicap toilet.
(11) Water resistant to allow use in a shower.
(12) Provides even distribution of tissue weight and skin surface tension.
(13) A device used for gigantomastia may have an adjustable upper platform to allow at least two positions for breast support while sitting or standing.
(14) The tissue support device (brassiere or cloth support) may be detachable to allow cleaning by laundry, or to compensate for changing tissue size over time.

The basic design of most embodiments of the invention is determined by basic human anatomy and physiology. The human skeleton with its associated muscular and tendon support is designed to support body weight with the center of gravity located directly over the center of the pelvis. A large amount of body weight with the center of gravity located far anterior to this position cannot be adequately supported by the skeletal structure. Patients with medical syndromes resulting in a large amount of anterior body weight will usually compensate by leaning backward while standing or walking, which places a large amount of excess physical stress on the lower spine. These patients typically suffer from chronic lower back pain. If anterior body weight becomes great enough, the patient typically is unable to walk more than a few steps, and eventually she is unable to stand without assistance. In severe cases, most patients are wheelchair bound or bedridden. However, if the anterior body weight can be well supported and the skeleton relieved of the physical stress of the weight, these patients can stand and walk normally with relatively minimal effort.

Because of the limitations of skeletal strength and position, the best way to support a large amount of anterior body weight is by transmitting the weight through a physical structure directly to the ground surface. By extending a supporting device from the ground up to the overhanging tissue, the skeleton can be entirely relieved of the gravitational force of the tissue, and of the moment arm generated by the offset center of gravity. If the support device has wheels, it can then be rolled freely across the ground surface which allows easy mobility of the patient, who can then simply push the excess tissue in front of her.

Embodiments of the invention are able to be utilized for several functions. These functions include but are not limited to the following three examples.
(1) Adequately supporting heavy tissue with the center of gravity significantly offset from the skeletal axis and relieving the skin and connective tissue of tension forces generated by this tissue weight.
(2) Allowing easy mobility of the patient by using wheels to roll the frame of the device along the ground surface.
(3) Maintaining adequate tissue support with at least two physiologic positions—sitting and also standing/ambulation.

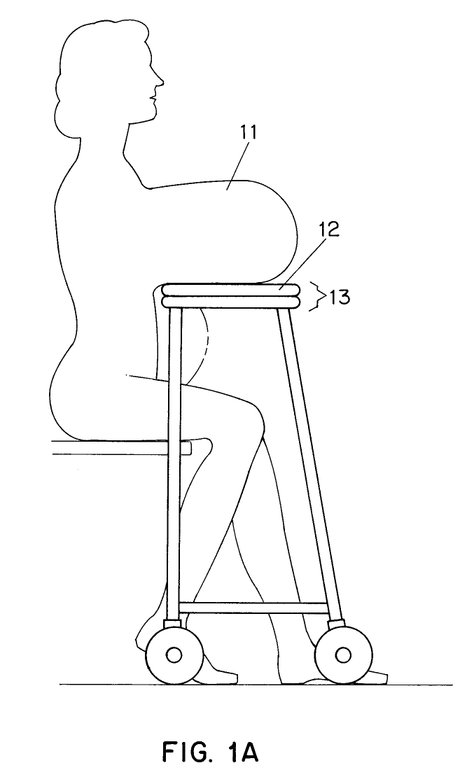

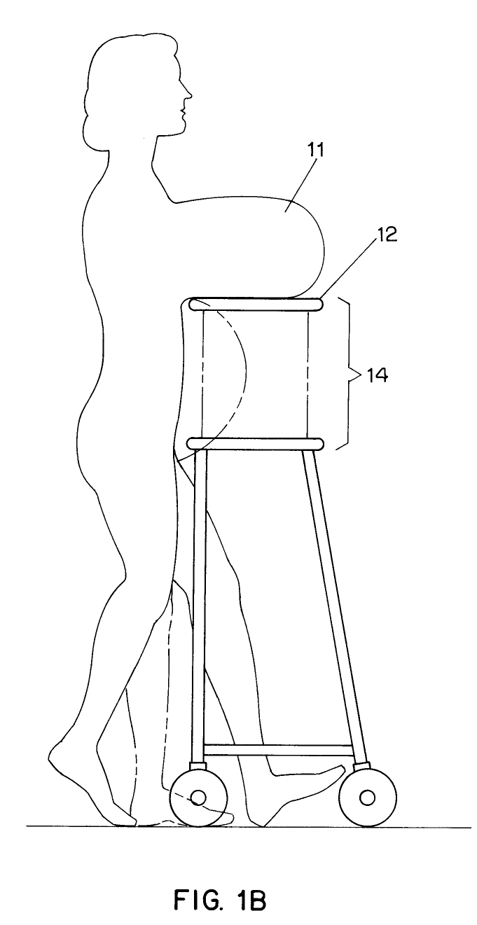

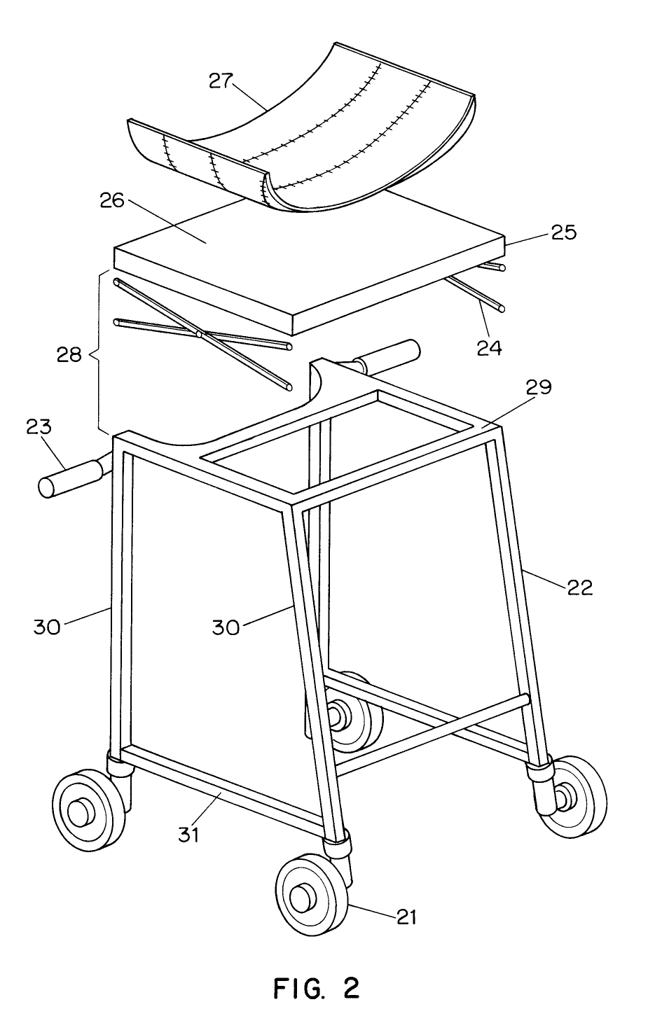

One embodiment of the invention is illustrated by FIGS. 1A and 1B. In these figures, the medical category of gigantomastia is used for illustration, but the general principles apply to all categories of excessive anterior body weight. The silhouette figures illustrate the basic requirement of the device to transmit anterior body weight directly to the ground, along with the ability to sit, stand, and walk with relative ease, and the ability to change the height of the tissue support platform during the transition from sitting to standing or from standing to sitting. This exemplary embodiment of the invention is also able to accommodate a third trimester pregnant abdomen or an obese abdomen.

The operation of the embodiment of the invention illustrated by FIGS. 1A and 1B is relatively simple. While in the sitting position illustrated by FIG. 1A, the patients breasts (11) are placed on the support platform (12). The frame is adjusted to a first height (13) to accommodate the sitting position so that the center of gravity of the breast is at the mid-chest level. This is done in order to minimize and evenly distribute the tissue forces in the skin and the internal ligaments at the breast/chest wall junction. When the patient stands up, as illustrated in FIG. 1B, the support platform (12) is elevated to a second height (14) so that the center of gravity of the breasts remains at the same relative position to the chest wall, and no new gravitational stress forces are applied to the skin and ligaments. The support platform may be raised by a mechanical lifting mechanism which is easy to operate. Once the support platform is in the upper position, it is firmly held or locked in place as long as the patient remains standing or is ambulating. When the patient returns to a sitting position, the support platform may then be lowered back to the original level by reversing the action of the mechanical lifting mechanism.

The basic design of one embodiment of the invention is illustrated by FIG. 2. This exemplary embodiment of the invention is comprised of five basic components:
(1) Wheels or rolling mechanism (21) at the ground level allow easy movement of the frame (22) across a walking surface.
(2) The support frame, (22) which transmits tissue weight down to the wheels (21) at ground level, may incorporate handles (23) for easy pushing, pulling, or maneuvering.
(3) A mechanical lifting mechanism (24) may be used to adjust the height (28) of the support platform (25) for the patient in sitting and standing positions.
(4) Support platform (25) provides a surface (26) for resting tissue weight.
(5) A brassiere or support sling (27) may be used to evenly distribute skin tissue forces and to transmit tissue weight to the support platform (25).

Each of the components of the embodiment of the invention described above will be individually discussed in detail in the following sections. Exemplary design variations for each of the components will also be described, with variations in these components intended to increase the versatility of the device and expand the application of the invention to a wide range of tissue weights, tissue types, medical indications, and mobility requirements.

In general, the invention will be used in clinical applications for a relatively short period of time by most patients. Nearly all clinical applications of the invention are characterized by short duration medical indications. Patients with gigantomastia will have natural involution of breasts after pregnancy, or will have surgical breast reduction within a few weeks. Patients with abdominal pannus will typically also use the invention for just a few weeks until plastic surgical correction can be done. The same is true for patients with large abdominal tumors. In this case, the invention would be used to assist in patient mobility up until the time that surgical removal of the tumor can be done. The invention would also no longer be needed shortly after delivery of a high multiple pregnancy.

Frame Design

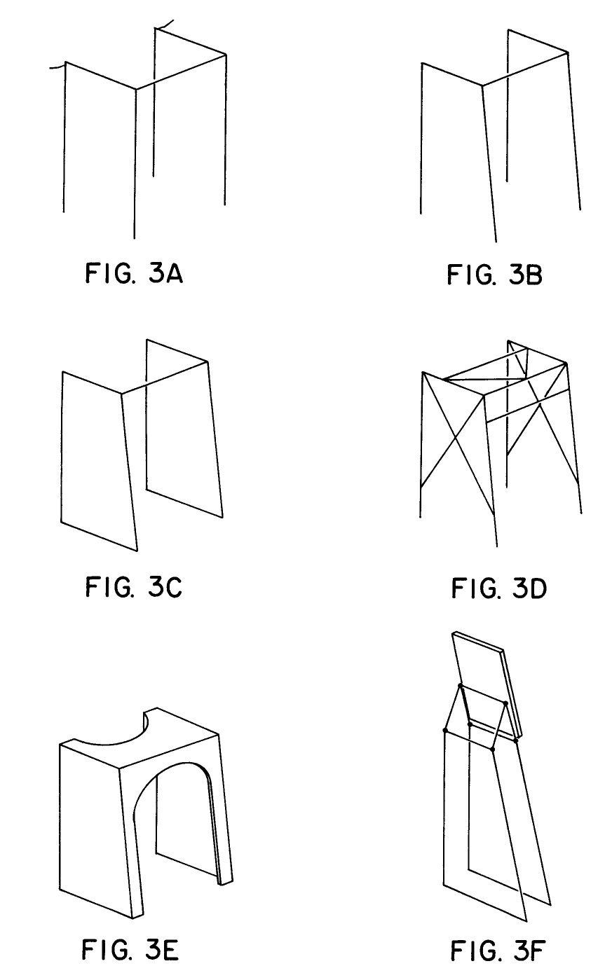

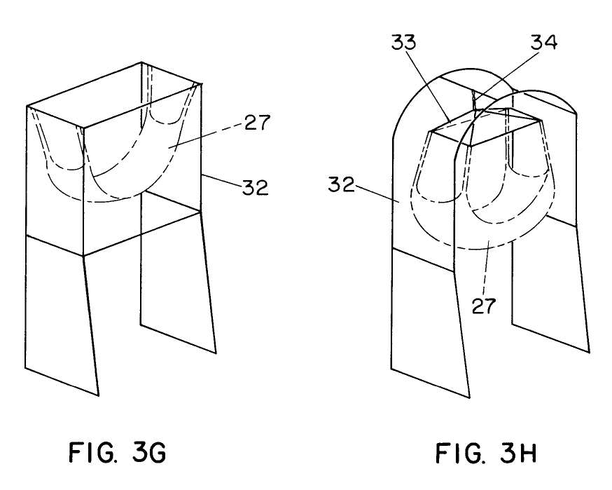

Several embodiments of design variations for the frame component of the invention are illustrated by FIGS. 3A-3H. Exemplary embodiments of the footprint of the frame include a square or rectangular shape as well as a triangle or u-shaped pattern. As illustrated in FIG. 2, the upper platform end (29) of the frame (also referred to the top portion) is incorporated, with typically four support struts (30) used to connect the upper portion (29) to the lower portion (31), with each support strut (30) transmitting the tissue weight toward the ground. As few as one and as many as six or more support struts can be incorporated into the device. Handles (23) used to push, pull, or maneuver the device are typically placed on the frame at the portion nearest the patient, with the height of the handles determined by the patient's height and by the specific mobility requirements, with intent to maximize the comfortable positioning of the arms and hands. It is also possible for the top portion of the frame to be a solid piece similar in shape and size to the support platform. Additional frame variations are illustrated by FIGS. 3A-3H and include the following:

FIG. 3A is an embodiment of the frame design where the support struts are vertical. This particular embodiment is a very simple design and is typically inexpensive for manufacturing.

FIG. 3B illustrates an embodiment of the frame with slanted or diagonal front struts which are designed to increase the distance between the wheels and lower frame in order to increase stability and minimize the risk of tipping the frame over.

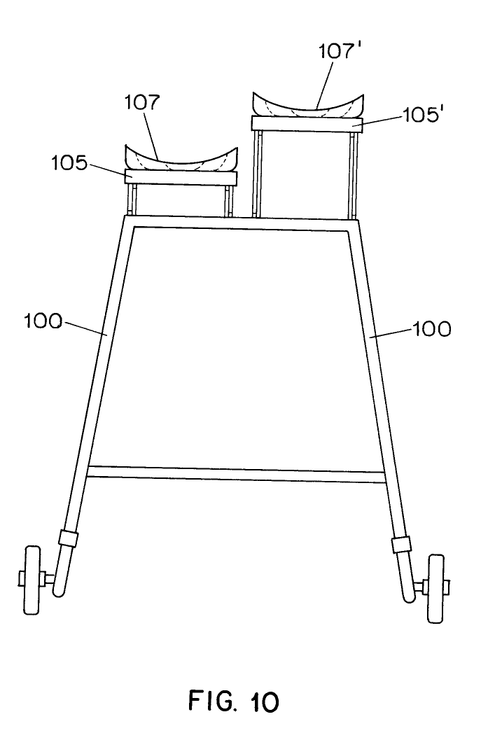

FIG. 3C illustrates an embodiment of the frame where a lower brace is used to connect the side struts in order to increase the strength and stability of the frame. The lower brace must be positioned so that it does not interfere with or contact feet or legs during normal ambulation. (See also FIG. 10, where a lower brace is used to connect the front struts for the same reason.)

FIG. 3D illustrates an embodiment of the frame where the support struts are cross braced at various positions, especially the lateral struts, beneath the support platform, or between the front or rear struts in order to further increase strength and stability of the frame. This design would be especially useful for very heavy tissue loads.

FIG. 3E illustrates an embodiment of the frame where a box frame construction is used to enclose the interior of the frame for further stability, as long as sufficient portions of the box are cut out to avoid collision or contact of the legs or feet during normal walking stride, or to accommodate a pregnant or obese abdomen.

FIG. 3F illustrates an embodiment of a folding frame designed to lie flat or occupy a smaller volume during storage and transportation of the invention. This would allow easy storage or transport in the back seat or trunk of a sedan automobile, or in a hospital room closet. The folding frame is designed so that the attached support platform can be either folded or extended to lie parallel with the rest of the frame in order to minimize the profile of the device.

FIG. 3G illustrates an embodiment of a frame where a suspension cage (32) can be used to hang the brassiere or tissue sling component (27) of the invention, simplifying the frame design and reducing the weight by eliminating the lifting mechanism and support platform. The suspension cage (32) may be constructed of additional struts placed on top of the frame to a level approximately that of the patient's height, with the upper portion of the struts connected by additional support members used to hang the brassiere or tissue sling (27).

FIG. 3H illustrates an embodiment of a frame where the suspension cage (32) can be modified to allow the height of the brassiere or tissue sling (27) to be adjustable. This embodiment incorporates a support grid (33) located beneath the highest portion of the suspension cage. The corners of the support grid are used to hold the straps leading down to the brassiere or tissue sling, and the rigid support grid itself is suspended below the cage frame by one or more ropes, cables, or chains (34). By mechanically adjusting the length of the rope, cable or chain, the brassiere or support sling can be elevated in height to allow the patient to change from sitting to standing position.

All of the various embodiments of the frame are designed to allow easy ambulation with adequate clearance for the feet and legs during normal ambulation, and to provide clearance for a third trimester pregnant abdomen or obese abdomen.

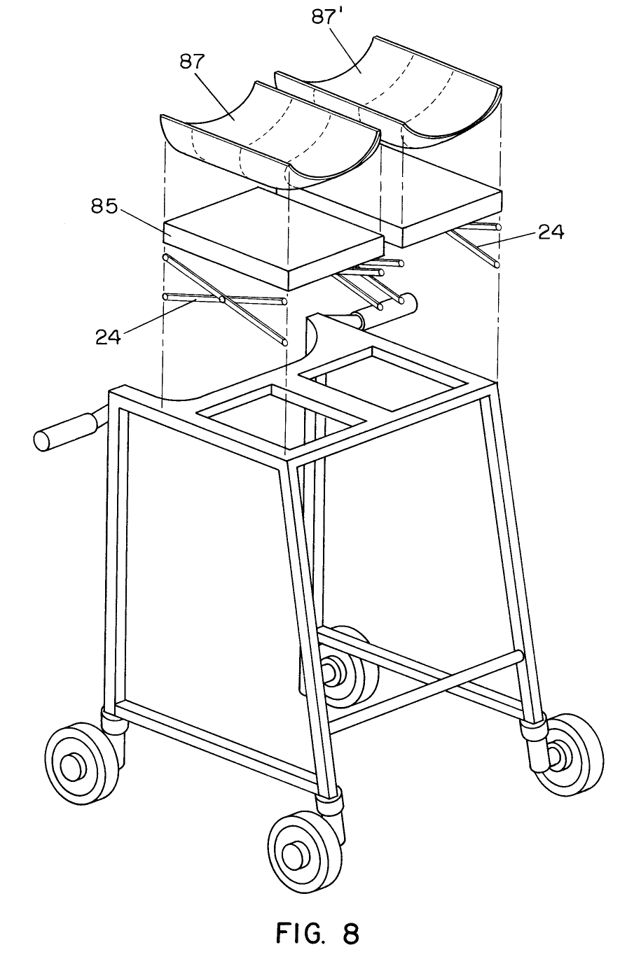

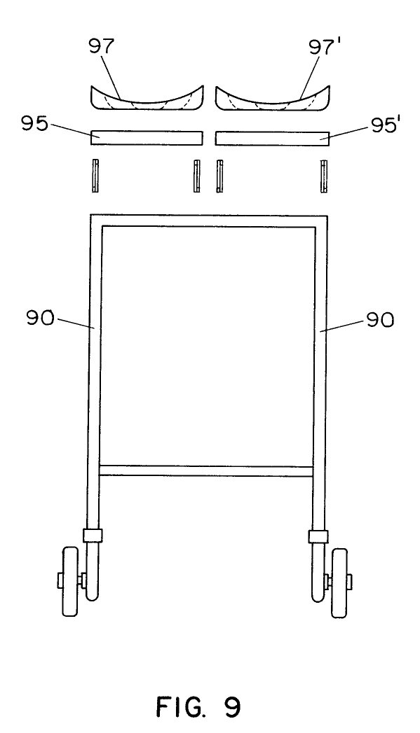

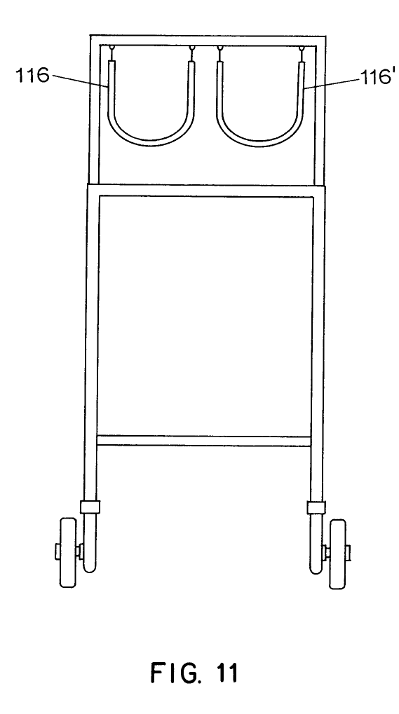

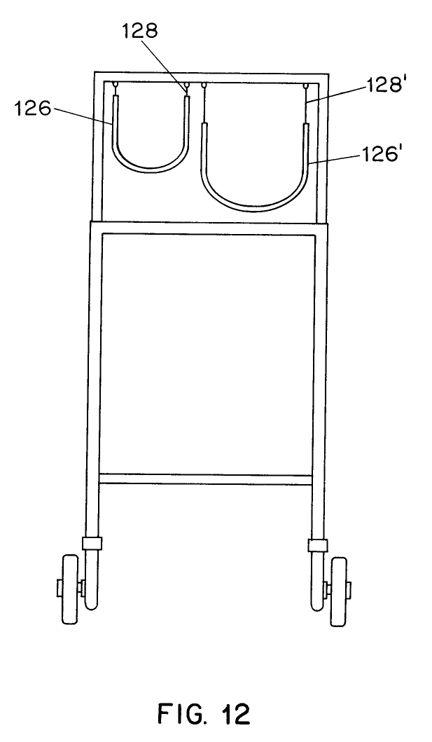

It is not unusual for women to have asymmetrically sized breasts. Conditions such as macromastia and gigantomastia often lead to very large size differences between two breasts where the size difference between the same two breasts were minimal prior to the development of the condition. For this reason as well as for addition support and comfort needs, one embodiment of the invention to has two separate support platforms and/or two separate support slings. By separating one support platform or sling into two, each platform or sling may be adjusted to different heights to accommodate the size of a particular breast. It may be more comfortable for a larger breast to be positioned at a lower level than a breast that was not quite so large. FIG. 8 is an illustration of an embodiment of the invention having two support platforms (85 and 85′), each adjustable to an individual height, and support slings (87 and 87′), each also adjustable with its corresponding support platform to an individual height. The heights for each support platform are adjusted with the mechanical lift mechanisms (24). FIG. 9 is an exploded front view of an embodiment of the invention showing two individual support platforms (95 and 95′) and two individual support slings (97 and 97′). In this illustration, the platforms and slings are positioned at the same level, but both could be adjusted to be at different levels as illustrated by FIG. 10. FIG. 9 also shows an embodiment of the frame having support struts (90) being positioned perpendicular with the floor. FIG. 10 illustrates an embodiment of the invention where the support platforms (105 and 105′) and support slings (107 and 107′) are not positioned at the same height. FIG. 10 also illustrates an embodiment of the invention where the support struts (100) of the frame are positioned at angles to the floor, providing a potentially more stable support structure overall. FIG. 11 is an illustration of an embodiment of the invention having two separate hanging slings (116 and 116′). In FIG. 11, the two slings (116 and 116′) are shown at the same height. However, the slings could be positioned as they are in FIG. 12, where one sling (126′) hangs slightly lower and is slightly larger to accommodate a larger breast than sling (126) which would hang slightly higher to accommodate a slightly smaller breast. It can be appreciated that there are many different ways that the slings could be hung at different heights. For example, one of the slings could contain more fabric, allowing it to hang lower while the other sling hangs higher because it contains less fabric. Another example would be two slings, each made with the same amount of fabric, but one hangs lower because it is suspended by a cable or chain or rope that is longer than the other. This is illustrated in FIG. 12 where the chain (128) that suspends sling (126) is shorter than the chain (128′) that suspends sling (126).

Although rare, it is possible for a patient suffering from gigantomastia or macromastia to also suffer from polymastia. In cases such as this, additional support platforms and/or support devices may be needed to accommodate the additional breasts resulting from the condition.

Wheel Variations

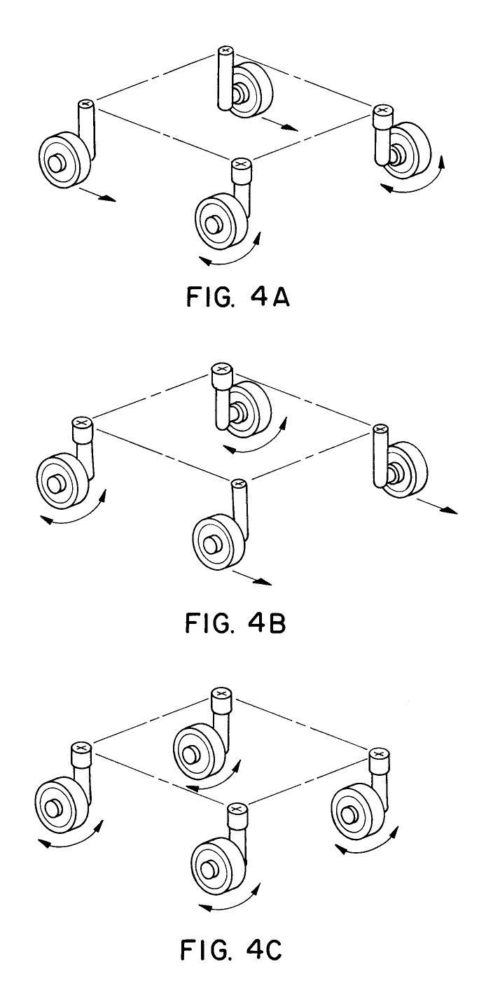

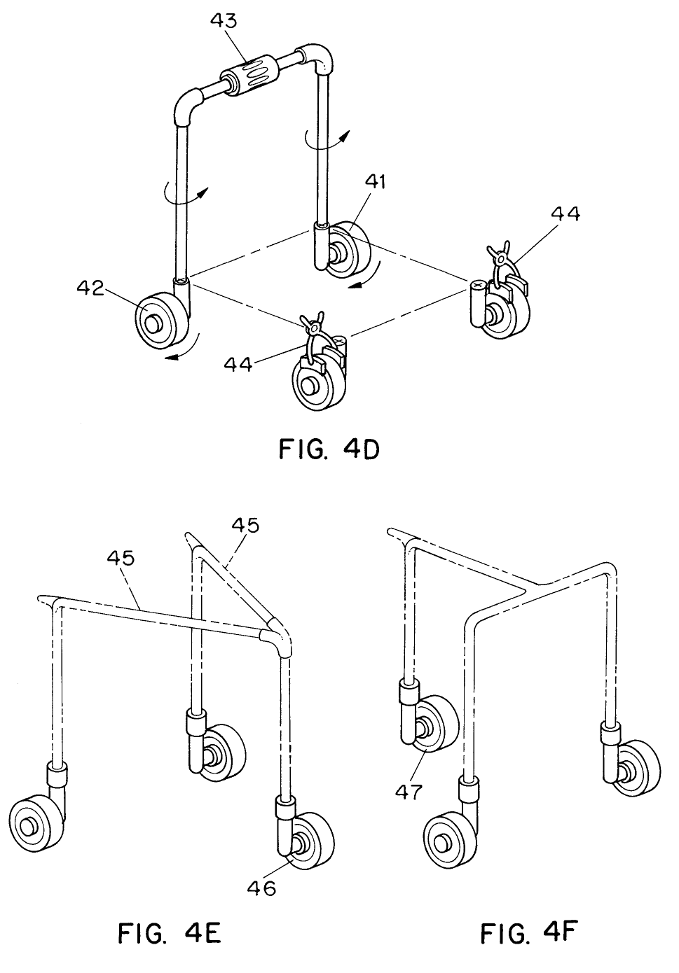

As illustrated in FIG. 2, in one embodiment of the invention, the frame (22) is supported on a base consisting of two, three, or four or more wheels (21) to allow easy rolling mobility across a walking surface. An exemplary embodiment of the invention incorporates the use of four wheels, with variations in wheel size, wheel pivoting for steering, and wheel position, which are customized to the frame type and medical application. Various embodiments of wheel design which are illustrated in FIG. 4A-4F include the following:

FIG. 4A illustrates an exemplary embodiment of the invention having front wheel steering, similar to that of a standard automobile, which accommodate the most likely maneuvering situations encountered.

FIG. 4B illustrates an exemplary embodiment of the invention having back wheel steering, similar to that of a forklift, which increases maneuverability in some specific indications, especially if backing up to a chair or toilet is required in a confined space such as a bathroom stall.

FIG. 4C illustrates an exemplary embodiment of the invention having all wheel steering, which is one of the most versatile designs for maneuvering situations, and which also allows lateral or rotational movement around the patient's body.

FIG. 4D illustrates an exemplary embodiment of the invention where the wheels (41 and 42) are powered by motors (43). This embodiment is especially useful for patients who are elderly, have muscle weakness, have very high frontal tissue weight, or who need to move up inclined surfaces. Control of wheel power is similar to that of powered wheelchairs. This design could also include wheel brakes (44). The brakes are very useful for very large tissue weights with associated high momentum, or for ambulating down inclined surfaces.

FIG. 4E illustrates an embodiment of the invention where the wheels are arranged in triangular shape wheels to fit a front triangle frame, with clearance for feet and legs during ambulation provided by placing the front wheel (46) at the midline with ambulating foot placement on each side of this wheel (46).

FIG. 4F illustrates an embodiment of the invention having a rear triangle design, with clearance for feet and legs during ambulation provided by ambulating placement of the feet on each side of the back wheel (47).

Mechanical Lifting Mechanism Variations

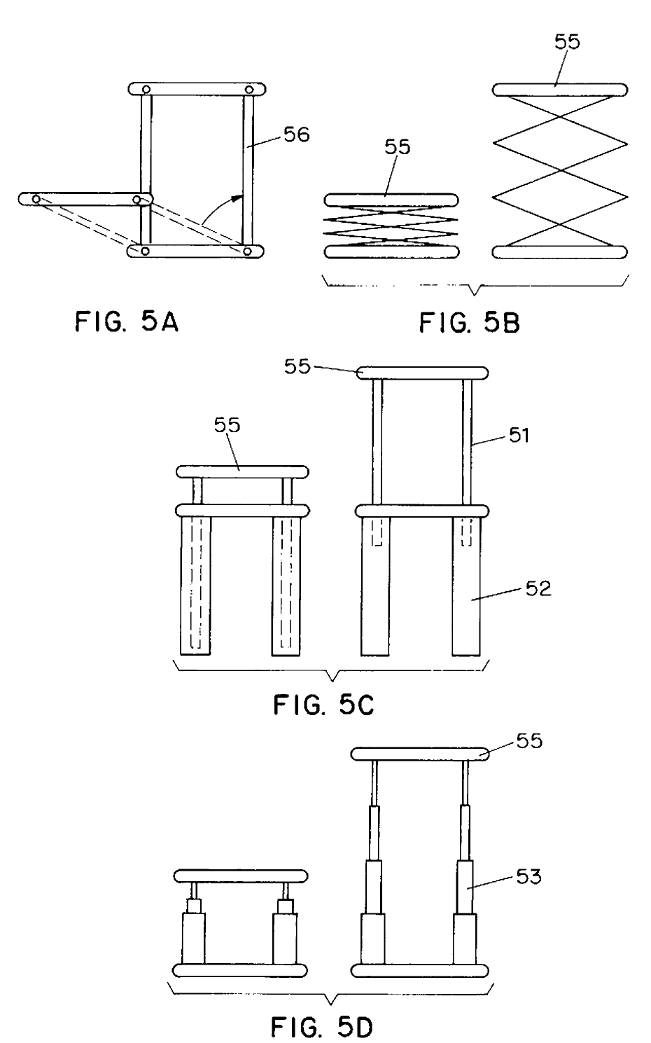

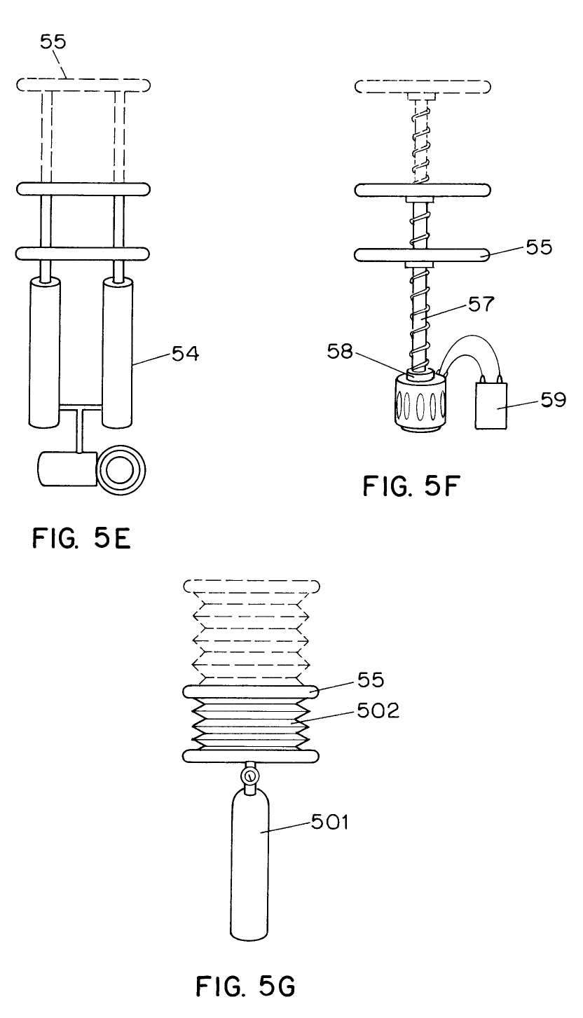

The mechanical lifting mechanism of one embodiment of the device is designed to enable the patient to lift or lower heavy tissue between the sitting and standing positions. The height of tissue support above the ground while in a sitting position may be set at a fixed distance for each individual patient. The height of tissue support above the ground when the patient is standing or walking also may be set at a fixed distance for each individual patient. A mechanical lifting mechanism is used to move the support platform up and down the sitting position and standing position elevations in a relative smooth and rapid manner, preferably with minimal effort by the patient. A large number of mechanical variations for the lift mechanism can adequately perform this function, some of which are illustrated by FIGS. 5A-5G and are described below:

FIG. 5A is an illustration of one embodiment of the mechanical lift mechanism in the form of a pivoted or hinged device. This embodiment has the advantage of allowing the support platform to not only be elevated from the sitting to the standing position, but also moves it horizontally toward the patient when the patient is seated. This would allow the patient to be positioned further away from the rolling frame while seated, permitting more leg room. However, if the center of gravity on the tissue on the platform is offset too far from the support frame, the frame is in danger of tipping over toward the patient. This concern can be addressed by use of a counterweight which pivots in a direction opposite of the support platform.

FIG. 5B illustrates a “scissor” variation of the invention's mechanical lift mechanism. This embodiment of the mechanical lift mechanism can be used to expand the support platform (55) in a vertical direction by drawing the scissor elements on the base platform closer together.

FIG. 5C illustrates a “piston” variation of the mechanical lift mechanism. This embodiment may be used to elevate the support platform (55) by encasing the support struts (51) inside cylinders (52), and allowing them to move up and down within the cylinders (52). Movement of the pistons may be achieved mechanically using cranes, ratchets, or springs.

FIG. 5D illustrates a “telescope” variation of the mechanical lift mechanism, which is actually another variation of the piston mechanism where concentric cylinders (53) are used as support struts.

FIG. 5E illustrates hydraulic or pneumatic cylinders (54) used to power the raising or lowering of the support platform (55) with compressed air, an air pump, or with a hydraulic pump. The compressed gas cylinder or the pump powered mechanism, along with the pump itself, can be incorporated within the lateral frame or base of the frame without compromising leg room.

FIG. 5F illustrates a rotating screw variation of the mechanical lift mechanism. This variation is typically powered by an electric motor which is then used to raise or lower the support platform alternatively by reversing the direction of the electric motor. In this rendition, the electric motor itself also moves up or down with the support platform, with the base platform remaining fixed on the top of the frame. The lower or lateral portions of the frame are used to hold the battery or other power source for the motor.

FIG. 5G illustrates an accordion variation of the mechanical lift mechanism. This variation is typically powered by compressed gas or fluid, with the tissue platform raised by movement of the compressed gas into the accordion, and lowered by release of the accordion gas into the atmosphere.

Platform Variations

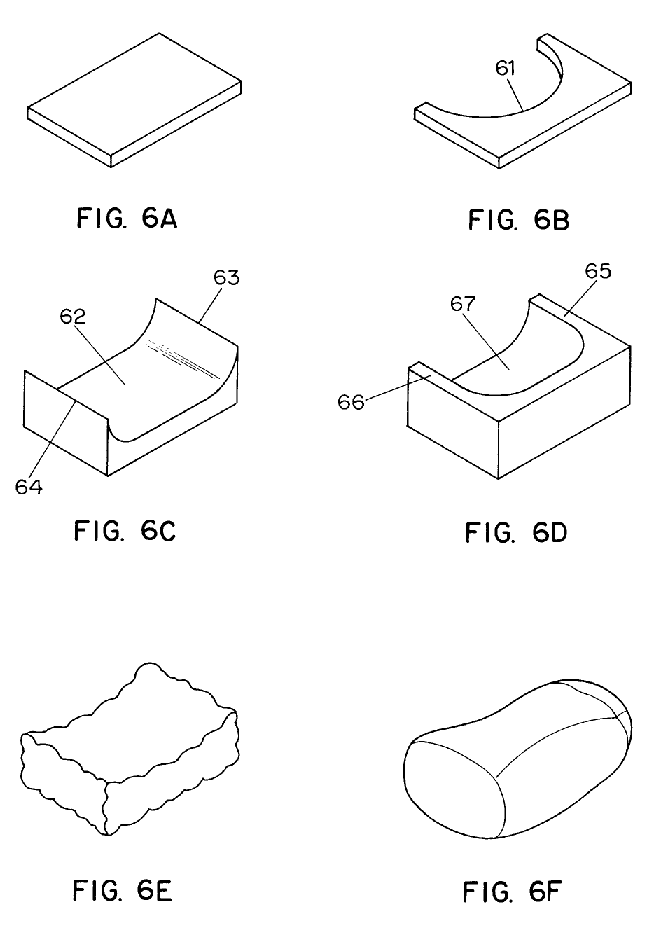

Embodiments of the support platform are typically flat or curved surfaces mounted on top of lifting mechanisms, and are designed to hold heavy tissue in a stable position on top of the support device. Several variations of the support platform are illustrated in FIGS. 6A-6F

FIG. 6A illustrates an embodiment of the support platform where the support platform is rectangular or square, and is made of rigid material such as wood, plastic, or fiberglass. Further variations of this particular embodiment of the platform include rounded corners, and a symmetric or asymmetric oblong shape.

FIG. 6B illustrates an embodiment of the support platform where the support platform is a recessed platform, typically with a curved relief (61) cut into the surface facing the patient. This allows accommodation of the patient's body below the supported tissue, typically an obese abdomen or pregnant abdomen.

FIG. 6C illustrates an embodiment of the support platform where the support platform is a U-shaped platform with elevated lateral sides to prevent lateral spills of supported tissue and to further increase the stability of the platform.

FIG. 6D illustrates an embodiment of the support platform where the support platform is a cupped platform having a deep half-cup shaped indentation (62) in the platform designed to approximate the shape of the supported tissue, and designed to prevent spill of tissue in a lateral or frontal direction.

FIG. 6E illustrates an embodiment of the support platform where the support platform is a foam or gel cushion having either a block of soft material or a custom molded blocked design to provide approximately equal force over the entire undersurface of the supported tissue. In general, the foam or gel cushion will self mold to the contour of the supported tissue by simple compression. The foam or gel cushion may work best if it is enclosed within a more rigid box or cage to minimize spill of tissue.

FIG. 6F illustrates and embodiment of the support platform where the support platform is a water, oil, or air filled bag. This embodiment allows even distribution of tissue forces along the undersurface of the supported tissue and has a design similar to that of the foam or gel cushion illustrated in FIG. 6E.

Brassiere and Tissue Sling or Support Device Variations

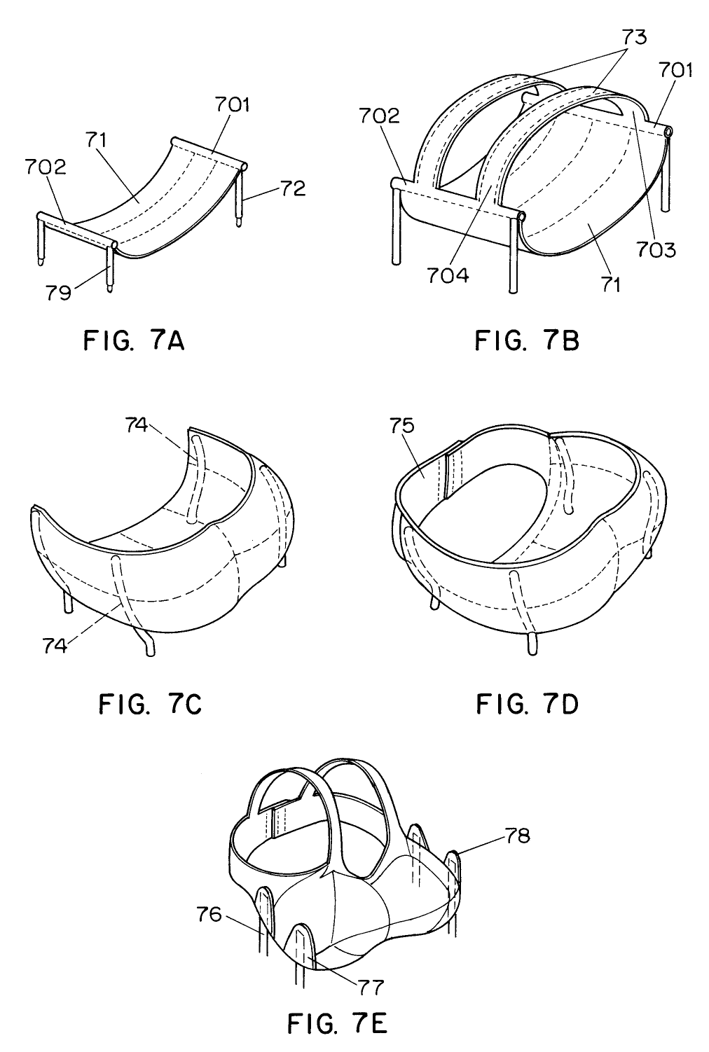

For many applications, a brassiere or tissue sling (also referred to as a support device) will provide better control of tissue weight than that provided by a support platform alone. In some cases, a brassiere or tissue sling could be used in addition to or instead of a support platform, depending on whether the sling can be directly connected to the mechanical lift mechanism. The brassiere or tissue sling may be made of cloth or similar flexible material which can be cut and sewn into custom sizes and shapes, depending on the tissue to be supported. Several exemplary variations of this component are illustrated in FIG. 7A-7E.

FIG. 7A illustrates an embodiment of a basic sling. This exemplary embodiment is comprised of a band of cloth (71) hung between two lateral supports (72 and 79) which are then connected to the support platform or mechanical lifting mechanism, with the heavy tissue resting within the sling.

FIG. 7B is an embodiment of a sling with straps. This embodiment is similar to the basic sling described in FIG. 7A, but with additional straps (73) used to drape over the top portion of the tissue to prevent lateral spillage of tissue or to decrease the lateral skin and connective tissue tension forces.

FIG. 7C is an embodiment of a custom cup cloth support cut and sewn to approximate the shape of tissue to be supported, typically with curved lateral and frontal support stays (74) or a cage of more rigid material designed to hold and approximate constant shape, and designed to transmit tissue weight to the support platform or lifting mechanism below.

FIG. 7D is an embodiment of a custom cup with back strap support which is similar to the variation illustrated by FIG. 7C, but with an extended strap (75) to wrap around the back of the patient which would further stabilize the tissue weight, and prevent stretching of skin and connective tissue if the supported weight moves to far in front of the patient.

FIG. 7E is an embodiment of a modified commercial brassiere. This embodiment provides tissue support with the use of a large size commercial brassiere which is modified to accommodate support struts (76) for the lifting mechanism or support platform. In general the modification is accomplished in one of two ways—by sewing additional pockets of material (77) around the periphery of the brassiere which are designed to encase the support struts, or by sewing lateral straps (78) to the front portion of the brassiere which are then used to suspend the brassiere from the top of a support frame using the suspension cage design. This has the advantage of eliminating the need for a support platform and moves the lifting mechanism to the top part of the suspension cage, by raising or lowering the support straps from above.

### Additional Embodiments of the Invention

An additional embodiment of the invention is a mobile medical device comprising a walker as shown in FIG. 2. The walker has a frame (22) with a top portion (29), a bottom portion (31), at least three support struts (30) extending downward from the top portion of the frame to the bottom portion of the frame, and at least two wheels (21) connected to the bottom portion of the frame and being arranged to permit the walker to roll along a surface. A support platform (25) for bearing anterior tissue weight of a patient is attached to the top portion of the frame.

As illustrated by FIG. 2, the support platform (25) may be attached to the top portion (29) of the frame (22) at a height and this height may be adjusted with a mechanical lifting mechanism (24).

One embodiment of the invention's mechanical lifting mechanism is illustrated by FIG. 5A. This mechanical lifting mechanism comprises at least one support arm (56). The at least one support arm (56) pivotably supports the support platform at a first and a second height. The first height is higher than the second height and the second height allows the support platform to be positioned horizontally closer to a seated patient.

Another embodiment of the invention's mechanical lifting mechanism is illustrated by FIG. 5B. Here the mechanical lifting mechanism comprises a scissor fold support mechanism. The scissor fold support mechanism supports the support platform (55) at positions between a first height and a second height. The right side of FIG. 5B shows the support platform at second height being higher than a first height which is illustrated on the left side of FIG. 5B. The left side of FIG. 5B shows the scissor fold support being in a completely compressed state and the right side of FIG. 5B shows the scissor fold support being in a completely extended state at the second height.

Another embodiment of the invention's mechanical lifting mechanism is illustrated by FIG. 5C. Here the mechanical lifting mechanism comprises a piston mechanism which has at least two support legs (51) extending downward from the support platform (55). Each of the at least two support legs (51) are encased inside a cylinder (52), and each of the at least two support legs (51) are capable of being mechanically upward and downward within each cylinder (52).

Another embodiment of the invention's mechanical lifting mechanism is illustrated by FIG. 5D. Here the mechanical lifting mechanism comprises a telescoping mechanism. The telescoping mechanism comprising at least two support legs (53) extending downward from the support platform (55). Each of the at least two support legs have at least two concentric cylinders. The telescoping mechanism supports the support platform (55) at positions between a first height and a second height. The second height is shown on the right side of FIG. 5D and is higher than the first height shown on the right side of FIG. 5D. The concentric cylinders are positioned completely inside one another at the first height and the concentric cylinders being completely extended from each other at the second height.

Another embodiment of the invention's mechanical lifting mechanism is illustrated by FIG. 5E. Here the mechanical lifting mechanism comprises at least one hydraulic or pneumatic cylinder (54).

Another embodiment of the invention's mechanical lifting mechanism is illustrated by FIG. 5F. Here the mechanical lifting mechanism comprises a rotating screw mechanism (57) and a base (58). The rotating screw mechanism (57) comprises at least one support leg extending downward from the support platform (55). The support leg has threads and screws into the base (58). The rotating screw mechanism supports the support platform (55) at positions between a first height and a second height. The second height is higher than the first height. The support platform is at a first height when the at least one support leg (57) is screwed into the base (58) as much as possible. The support platform is at a second height when the at least one support leg (57) is unscrewed from the base (58) as much as possible without dislodging from said base. The rotating screw mechanism may also be powered by an electric motor attached to the base. A power source (59) is shown in FIG. 5F for powering the electric motor attached to the base.

Another embodiment of the invention's mechanical lifting mechanism is illustrated by FIG. 5G. Here the mechanical lifting mechanism comprises an accordion mechanism (502). The accordion mechanism (502) extends downward from the support platform (55) and supports the support platform at positions between a first height and a second height. The first height is lower than the second height. The accordion mechanism (502) is completely compressed at the first height and completely extended at the second height. A mobile medical device with an accordion mechanism may further comprise compressed gas which is capable of flowing into the accordion mechanism (502) from a compressed gas container (501) and out of the accordion mechanism (502) into a compressed gas container (501). The accordion mechanism (502) is at a first height when all of the compressed gas is located in the compressed gas container (501). The accordion mechanism (502) is at a second height when all of the compressed gas is located within the accordion mechanism. Instead of or in addition to compressed gas, the accordion mechanism (502) could comprise a liquid capable of flowing into the accordion mechanism from a container and out of the accordion mechanism into a container. The accordion mechanism would be at a first height when all of the liquid is located in the container, and at a second height when all of the liquid is located within the accordion mechanism.

There are several different embodiments available for the support platform of the invention. FIG. 6A illustrates a support platform characterized as being comprised of a rigid material and having a rectangular shape. The support platform also could have rounded corners. Another embodiment of the support platform is comprised of a rigid material and has a symmetrical oblong shape. The support platform also could be comprised of a rigid material and having an asymmetrical oblong shape. Another embodiment of the support platform is shown by FIG. 6B with a surface (61) which faces a patient. Surface 61 has a curved relief cut into it, and is positioned so that curved relief curves away from the patient. The support platform also could be unshaped as shown by FIG. 6C. An embodiment of the support platform illustrated in FIG. 6C has a top surface. The top surface is positioned in parallel with the surface which the walker rolls along. The top surface has a right side (63) with a height, a left side (64) with a height and a middle (62) with a height. The top surface further comprises a hollowed curve which causes the height of the right side (63) of the top surface and the height of the left side (64) of the top surface to both be higher than the height of the middle (62) of the top surface. Yet another embodiment of the support platform of the mobile medical device is shown in FIG. 6D where the support platform is unshaped and has a top surface. The top surface is positioned in parallel with the surface which the walker rolls along. The top surface has a right side (65) with a height, a left side (66) with a height and a middle (67) with a height, said top surface further comprising a hollowed curve which causes the height of the right side (65) of the top surface and the height of the left side (66) of the top surface to both be higher than the height of the middle (66) of the top surface. The support platform may also comprise a soft material as shown by FIG. 6E and the soft material may comprise a foam cushion, a gel cushion, a liquid filled bag, or an air filled bag as shown in FIG. 6F.

As illustrated by FIG. 2 in addition to comprising a walker with a frame (22) having a top portion (29), a bottom portion (31), at least three support struts (30) extending downward from the top portion of the frame to the bottom portion of the frame, and at least two wheels (21) connected to the bottom portion of the frame and being arranged to permit the walker to roll along a surface; and a support platform (25) for bearing anterior tissue weight of a patient is attached to the top portion of the frame; an embodiment of the invention may further comprise a support device (27) for evenly distributing anterior tissue and transmitting anterior tissue weight to the support platform. This support device could also be used in combination with any of the mechanical lifting mechanisms (24) and support platforms (25) described above. As shown in FIG. 7A, the support device may comprise a band of cloth (71), said band of cloth having first (701) and second ends (702) and being suspended between a first (72) and second (79) lateral support by the first and second ends, said lateral supports each being connected to the support platform. Another embodiment of the invention comprises a support device for evenly distributing anterior tissue and transmitting anterior tissue weight to the support platform. An embodiment of the mobile medical device also may have a support device comprising a band of cloth suspended between a first and second lateral support, and the lateral supports are each connected to the lifting mechanism. Another embodiment of the support device is shown in FIG. 7B comprises straps (73). The straps (73) each have first (703) and second (704) ends and the straps are positioned above the band of cloth (71). The first ends (703) of the straps are attached to the first end (701) of the band of cloth and the second ends (704) of the straps are attached to the second end (703) of the band of cloth. This embodiment of the support device may be connected to the support platform or to the lifting mechanism.

Because the anterior tissue of the patient is often breast tissue, one embodiment of the support device comprises a brassiere as shown in FIGS. 7C, 7D, and &E. FIG. 7C shows an embodiment of the support device where the brassiere is further characterized in that it is backless and strapless. FIG. 7D illustrates an embodiment of the support device where the brassiere comprises a back and is strapless. FIG. 7E shows an embodiment of the support device further characterized in that the brassiere comprises a back and two shoulder straps. As illustrated in FIG. 7C, another embodiment of a support device comprising a brassiere is further characterized in that the brassiere has two curved lateral and frontal support stays (74) comprising a rigid material designed to maintain the shape of the brassiere and each being connected to the support platform for the purpose of transmitting the breast tissue weight to the support platform. All of the above support devices that comprise a brassiere can be further characterized in that the support platform is attached to the top portion of the frame at a height and further comprises a mechanical lifting mechanism for adjusting the height of the support platform.

It is not required that all embodiments of the invention have a support platform. Some instead have a support device acting alone like a sling. One embodiment of the invention comprises a walker which comprises a frame with a top portion, a bottom portion, at least three support struts extending downward from the top portion of the frame to the bottom portion of the frame, and at least two wheels connected to the bottom portion of the frame and being arranged to permit the walker to roll along a surface. A cloth support device is then used for evenly distributing breast tissue by being connected to and transmitting breast tissue weight to the top portion of the frame. That support device could comprise a brassiere or a simple sling as shown in FIGS. 3G and 3H. If the support device is a brassiere, that brassiere could be further characterized as being backless and strapless, having a back and being strapless, or having a back and two shoulder straps. An additional embodiment of the support device having a backless strapless brassiere may be further characterized in that the backless strapless brassiere has curved lateral and frontal support stays made of a rigid material designed to maintain the shape of the backless strapless brassiere and each being connected to the top portion of the frame for the purpose of transmitting the breast tissue weight to the top portion of the frame. A mechanical lifting mechanism may be used to adjust the heights of the cloth support device.

There are several embodiments of the method for utilizing the invention for anterior tissue which may or may not be breast tissue. A first embodiment of the method of the invention is a method for supporting anterior tissue weight of a patient and increasing mobility of the patient. This method (as illustrated in FIG. 1B) comprises the step of placing the anterior tissue (11) on top of a support platform (12), said support platform being attached to the top of a standard walker comprising a frame having a top section and a bottom section and at least two wheels connected to the bottom section, said wheels being arranged to permit the walker to roll along a surface, said support platform being at a first height; and the step of the patient taking at least one step forward while the anterior tissue (11) is positioned on top of and supported by the support platform (12) attached to the top of the walker. Another embodiment of the method of the invention comprises the additional step of adjusting the support platform (12) from the first height (FIG. 1B, part 14) to a second height (FIG. 1A, part 13), said second height (13) which would accommodate the patient sitting while the anterior tissue (11) is positioned on top of the support platform (12). The patient would then sit while the anterior tissue (11) is located on top of and supported by the support platform (12) attached to the top of the walker. Another embodiment of the method of the invention may further comprise the steps of adjusting the support platform (12) to a third height with a mechanical lifting mechanism. The third height allows the patient to stand while the anterior tissue (11) is positioned on top of the support platform (12). The patient then stands and the patient takes at least one step forward while the anterior tissue (11) is located on top of and supported by the support platform (12) attached to the top of the walker. As an alternative, an embodiment of the method of the invention may further comprise the steps of: removing the anterior tissue (11) from the support platform (12); adjusting the support platform (12) to a third height, said third height allowing the patient to stand; the patient standing; replacing the anterior tissue (11) on top of the support platform (12); the patient taking at least one step forward while the anterior tissue (11) is located on top of and supported by the support platform (12) attached to the top of the walker.

Another embodiment of the method of the invention for supporting anterior tissue weight of a patient and increasing mobility of the patient comprises the step of: placing the anterior tissue on top of a support platform. The support platform is attached to a top portion of a frame. The frame as illustrated by FIG. 2 comprises: a top portion (29), a bottom portion (31), at least three support struts (30) extending downward from the top portion (29) of the frame to the bottom portion (31) of the frame, and at least two wheels (21) connected to the bottom portion (31) of the frame, said wheels being arranged to permit the frame to roll along a surface. The patient then takes at least one step forward while the anterior tissue is supported by the support platform (25) attached to the top portion of the frame (29).

Another embodiment of the invention's method for supporting anterior tissue weight of a patient and increasing mobility of the patient comprises the steps of: placing the anterior tissue on top of a support device, said support device evenly distributing the anterior tissue and transmitting anterior weight to a support platform, said support platform attached to a top portion of a frame, said frame comprising: a top portion, a bottom portion, at least three support struts extending downward from the top portion of the frame to the bottom portion of the frame, and at least two wheels connected to the bottom portion of the frame, said wheels being arranged to permit the frame to roll along a surface; the patient taking at least one step forward while the anterior tissue is supported by the support platform attached to the top portion of the frame. This embodiment of the method of the invention may further comprise the step of raising the height of the support platform with a mechanical lifting mechanism and the patient standing up prior to the patient taking at least one step forward while the anterior tissue is supported by the support platform.

Another embodiment of the invention's method for supporting excess breast tissue weight of a patient and increasing mobility of the patient comprises the steps of: placing the breast tissue into a cloth support device, said cloth support device comprising a brassiere and being connected to and transmitting breast tissue weight to a top portion of a frame, said frame forming a walker and comprising: a top portion, at least three support struts extending downward from the top portion of the frame to the bottom portion of the frame, and at least two wheels connected to the bottom portion of the frame, said wheels being arranged to permit the walker to roll along a surface; and the patient taking at least one step forward while the breast tissue is supported by the cloth support device attached to the top portion of the frame. This embodiment of the method may further comprise the step of adjusting the height of the cloth support device with a mechanical lifting mechanism.

As described above, there may be instances where it would be more comfortable for the patient to have support platforms or support devices that are two pieces with a division down the midline. Thus an additional embodiment of the invention is a mobile medical device which comprises a walker with a frame having a top portion, a bottom portion, at least three support struts extending downward from the top portion of the frame to the bottom portion of the frame, and at least two wheels connected to the bottom portion of the frame and being arranged to permit the walker to roll along a surface. This embodiment of the invention also comprises a first support platform for bearing right breast tissue weight of a patient, and a second support platform for bearing left breast tissue weight of a patient, each of said support platforms attached to respective sides of the top portion of the frame. Another embodiment of the invention could further comprise a first support device for evenly distributing right breast tissue and a second support device for evenly distributing left breast tissue, each support device transmitting breast tissue weight to a respective support platform. Another embodiment of the invention could have the first support platform is attached to the top portion of the frame at a first height and the second support platform is attached to the top portion of the frame at a second height; and further comprise a first and second lifting mechanism for adjusting the height of each respective support platform. The first height of the first support platform could be the same as the second height of the second support platform or could be different than the second height of the second support platform. In another embodiment of the invention, the first support platform is attached to the top portion of the frame at a first height and the second support platform is attached to the top portion of the frame at a second height; and the mobile medical device further comprises a first and second lifting mechanism for adjusting the height of each respective support platform. The first height of the first support platform could be the same as the second height of the second support platform or the first height of the first support platform could be different than the second height of the second support platform. Yet another embodiment of the invention could comprise a walker having a frame which comprises: a top portion, a bottom portion, at least three support struts extending downward from the top portion of the frame to the bottom portion of the frame, and at least two wheels connected to the bottom portion of the frame and being arranged to permit the walker to roll along a surface; a first cloth support device for evenly distributing right breast tissue and being connected to and transmitting right breast tissue weight to the top portion of the frame, and a second support device for evenly distributing left breast tissue and being connected to and transmitting left breast tissue weight to the top portion of the frame.

Those skilled in the art will have no difficulty devising myriad obvious variations and improvements upon the invention without departing from its teachings, all of which variations and improvements are intended to be encompassed by the claims which follow.

What is claimed is:

1. A mobile medical device comprising:
a walker, said walker comprising:
a frame, said frame comprising: a top portion, a bottom portion, at least three support struts extending downward from the top portion of the frame to the bottom portion of the frame, and at least two wheels connected to the bottom portion of the frame and being arranged to permit the walker to roll along a surface;
a support platform for bearing anterior tissue weight of a patient, said support platform attached to the top portion of the frame.

2. The mobile medical device of claim 1 wherein the support platform is attached to the top portion of the frame at a height and further comprises a mechanical lifting mechanism for adjusting the height of the support platform.

3. The mobile medical device of claim 2 wherein the mechanical lifting mechanism is further characterized in that it comprises at least one support arm,
said support arm pivotably supporting the support platform at a first and a second height,
said first height being higher than said second height and said second height allowing the support platform to be positioned horizontally closer to a seated patient.

4. The mobile medical device of claim 2 wherein the mechanical lifting mechanism is further characterized in that it comprises a scissor fold support mechanism, said scissor fold support mechanism supporting the support platform at positions between a first height and a second height, said second height being higher than said first height, said scissor fold support being in a completely compressed state at said first height and said scissor fold support being in a completely extended state at said second height.

5. The mobile medical device of claim 2 wherein the mechanical lifting mechanism comprises a piston mechanism,
said piston mechanism comprising at least two support legs extending downward from the support platform,
each of the at least two support legs encased inside a cylinder,
and each of the at least two support legs capable of being mechanically upward and downward within each cylinder.

6. The mobile medical device of claim 2 wherein the mechanical lifting mechanism comprises a telescoping mechanism,
said telescoping mechanism comprising at least two support legs extending downward from the support platform,
each of the at least two support legs comprising at least two concentric cylinders,
said telescoping mechanism supporting the support platform at positions between a first height and a second height,
said second height being higher than said first height,
said concentric cylinders being positioned completely inside one another at said first height and said concentric cylinders being completely extended from each other at said second height.

7. The mobile medical device of claim 2 wherein the mechanical lifting mechanism comprises at least one hydraulic cylinder.

8. The mobile medical device of claim 2 wherein the mechanical lifting mechanism comprises at least one pneumatic cylinder.

9. The mobile medical device of claim 2 wherein the mechanical lifting mechanism comprises a rotating screw mechanism and a base,
said rotating screw mechanism comprising at least one support leg extending downward from the support platform,
said support leg having threads and screwing into the base,
said rotating screw mechanism supporting the support platform at positions between a first height and a second height,
said second height being higher than said first height,
said support platform being at a first height when the at least one support leg is screwed into the base as much as possible,
said support platform being at a second height when the at least one support leg is unscrewed from the base as much as possible without dislodging from said base.

10. The mobile medical device of claim 9 wherein the rotating screw mechanism is powered by an electric motor attached to the base.

11. The mobile medical device of claim 2 wherein the mechanical lifting mechanism comprises an accordion mechanism said accordion mechanism extending downward from the support platform and supporting the support platform at positions between a first height and a second height, said first height being lower than said second height, said accordion mechanism being completely compressed at said first height and completely extended at said second height.

12. The mobile medical device of claim 11 wherein the accordion mechanism further comprises compressed gas capable of flowing into the accordion mechanism from a compressed gas container and out of the accordion mechanism into a compressed gas container, said accordion mechanism being at a first height when all of the compressed gas is located in the compressed gas container, and said accordion mechanism being at a second height when all of the compressed gas is located within the accordion mechanism.

13. The mobile medical device of claim 11 wherein the accordion mechanism further comprises a liquid capable of flowing into the accordion mechanism from a container and out of the accordion mechanism into a container, said accordion mechanism being at a first height when all of the liquid is located in the container, and said accordion mechanism being at a second height when all of the liquid is located within the accordion mechanism.

14. The mobile medical device of claim 1 wherein the support platform is further characterized as being comprised of a rigid material and having a rectangular shape.

15. The mobile medical device of claim 14 wherein the support platform is further characterized as having rounded corners.

16. The mobile medical device of claim 1 wherein the support platform is further characterized as being comprised of a rigid material and having a symmetrical oblong shape.

17. The mobile medical device of claim 1 wherein the support platform is further characterized as being comprised of a rigid material and having an asymmetrical oblong shape.

18. The mobile medical device of claim 1 wherein the support platform is further characterized as having a surface which faces a patient, said surface having a curved relief cut into it, said curved relief curving away from the patient.

19. The mobile medical device of claim 1 wherein the support platform is u-shaped in that the support platform has a top surface, said top surface being positioned in parallel with the surface which the walker rolls along, said top surface having a right side with a height, a left side with a height and a middle with a height, said top surface further comprising a hollowed curve which causes the height of the right side of the top surface and the height of the left side of the top surface to both be higher than the height of the middle of the top surface.

20. The mobile medical device of claim 18 wherein the support platform is u-shaped in that the support platform has a top surface, said top surface being positioned in parallel with the surface which the walker rolls along, said top surface having a right side with a height, a left side with a height and a middle with a height, said top surface further comprising a hollowed curve which causes the height of the right side of the top surface and the height of the left side of the top surface to both be higher than the height of the middle of the top surface.

21. The mobile medical device of claim 1 wherein the support platform comprises a soft material.

22. The support platform of claim 21 further characterized in that the soft material comprises a foam cushion.

23. The support platform of claim 21 further characterized in that the soft material comprises a gel cushion.

24. The support platform of claim 21 further characterized in that the soft material comprises a liquid filled bag.

25. The support platform of claim 21 further characterized in that the soft material comprises an air filled bag.

26. The mobile medical device of claim 1 further comprising a support device for evenly distributing anterior tissue and transmitting anterior tissue weight to the support platform.

27. The mobile medical device of claim 26 wherein the support device comprises a band of cloth, said band of cloth having first and second ends and being suspended between a first and second lateral support by the first and second ends, said lateral supports each being connected to the support platform.

28. The mobile medical device of claim 2 further comprising a support device for evenly distributing anterior tissue and transmitting anterior tissue weight to the support platform.

29. The mobile medical device of claim 28 wherein the support device comprises a band of cloth, said band of cloth being suspended between a first and second lateral support, said lateral supports each being connected to the lifting mechanism.

30. The mobile medical device of claim 27 wherein the support device further comprises straps, said straps each having first and second ends and said straps being positioned above the band of cloth, said first ends of said straps being attached to the first end of the band of cloth and said second ends of said straps being attached to the second end of the band of cloth.

31. The mobile medical device of claim 29 wherein the support device further comprises straps, said straps each having first and second ends and said straps being positioned above the band of cloth, said first ends of said straps being attached to the first end of the band of cloth and said second ends of said straps being attached to the second end of the band of cloth.

32. The mobile medical device of claim 26, further characterized in that the anterior tissue of the patient is breast tissue and the support device comprises a brassiere.

33. The mobile medical device of claim 32 wherein the brassiere is further characterized in that it is backless and strapless.

34. The mobile medical device of claim 32 further characterized in that the brassiere comprises a back and is strapless.

35. The mobile medical device of claim 32 further characterized in that the brassiere comprises a back and two shoulder straps.

36. The mobile medical device of claim 32 further characterized in that the brassiere has two curved lateral and frontal support stays comprising a rigid material designed to maintain the shape of the brassiere and each being connected to the support platform for the purpose of transmitting the breast tissue weight to the support platform.

37. The mobile medical device of claim 32 further characterized in that the support platform is attached to the top portion of the frame at a height and further comprises a mechanical lifting mechanism for adjusting the height of the support platform.

38. The mobile medical device of claim 37 further characterized in that the brassiere is backless and strapless.

39. The mobile medical device of claim 37 further characterized in that the brassiere comprises a back and is strapless.

40. The mobile medical device of claim 37 further characterized in that the brassiere comprises a back and two shoulder straps.

41. The mobile medical device of claim 38 being further characterized in that the brassiere has curved lateral and frontal support stays made of a rigid material designed to maintain the shape of the backless strapless brassiere and each being connected to the support platform for the purpose of transmitting the breast tissue weight to the support platform.

42. A mobile medical device comprising a walker, said walker comprising:
a frame, said frame comprising: a top portion, a bottom portion, at least three support struts extending downward from the top portion of the frame to the bottom portion of the frame, and at least two wheels connected to the bottom portion of the frame and being arranged to permit the walker to roll along a surface;
a cloth support device for evenly distributing breast tissue, said cloth support device being connected to and transmitting breast tissue weight to the top portion of the frame, said support device comprising a brassiere.

43. The mobile medical device of claim 42 further characterized in that the brassiere is backless and strapless.

44. The mobile medical device of claim 42 further characterized in that the brassiere comprises a back and is strapless.

45. The mobile medical device of claim 42 further characterized in that the brassiere comprises a back and two shoulder straps.

46. The mobile medical device of claim 43 being further characterized in that the backless strapless brassiere has curved lateral and frontal support stays made of a rigid material designed to maintain the shape of the backless strapless brassiere and each being connected to the top portion of the frame for the purpose of transmitting the breast tissue weight to the top portion of the frame.

47. The mobile medical device of claim 42 further comprising a mechanical lifting mechanism for adjusting the height of the cloth support device.

48. A method for supporting anterior tissue weight of a patient and increasing mobility of the patient, said method comprising the steps of:
placing the anterior tissue on top of a support platform, said support platform being attached to the top of a standard walker comprising a frame having a top section and a bottom section and at least two wheels connected to the bottom section, said wheels being arranged to permit the walker to roll along a surface, said support platform being at a first height;
the patient taking at least one step forward while the anterior tissue is positioned on top of and supported by the support platform attached to the top of the walker.

49. The method of claim 48, wherein the anterior tissue is breast tissue.

50. The method of claim 48, further comprising the steps of:
adjusting the support platform from the first height to a second height, said second height which would accommodate the patient sitting while the anterior tissue is positioned on top of the support platform;
the patient sitting while the anterior tissue is located on top of and supported by the support platform attached to the top of the walker.

51. The method of claim 50, further comprising the steps of:
adjusting the support platform to a third height with a mechanical lifting mechanism, said third height allowing the patient to stand while the anterior tissue is positioned on top of the support platform;
the patient standing;
the patient taking at least one step forward while the anterior tissue is located on top of and supported by the support platform attached to the top of the walker.

52. The method of claim 50, further comprising the steps of:
removing the anterior tissue from the support platform;
adjusting the support platform to a third height, said third height allowing the patient to stand;
the patient standing;
replacing the anterior tissue on top of the support platform;
the patient taking at least one step forward while the anterior tissue is located on top of and supported by the support platform attached to the top of the walker.

53. A method for supporting anterior tissue weight of a patient and increasing mobility of the patient, said method comprising the steps of:
placing the anterior tissue on top of a support platform, said support platform attached to a top portion of a frame, said frame comprising: a top portion, a bottom portion, at least three support struts extending downward from the top portion of the frame to the bottom portion of the frame, and at least two wheels connected to the bottom portion of the frame, said wheels being arranged to permit the frame to roll along a surface;
the patient taking at least one step forward while the anterior tissue is supported by the support platform attached to the top portion of the frame.

54. A method for supporting anterior tissue weight of a patient and increasing mobility of the patient, said method comprising the steps of:
placing the anterior tissue on top of a support device, said support device evenly distributing the anterior tissue and transmitting anterior weight to a support platform, said support platform attached to a top portion of a frame, said frame comprising: a top portion, a bottom portion, at least three support struts extending downward from the top portion of the frame to the bottom portion of the frame, and at least two wheels connected to the bottom portion of the frame, said wheels being arranged to permit the frame to roll along a surface;
the patient taking at least one step forward while the anterior tissue is supported by the support platform attached to the top portion of the frame.

55. The method of claim 54 further comprising the steps of raising the height of the support platform with a mechanical lifting mechanism and the patient standing up prior to the patient taking at least one step forward while the anterior tissue is supported by the support platform.

56. A method for supporting excess breast tissue weight of a patient and increasing mobility of the patient, said method comprising the steps of:
placing the breast tissue into a cloth support device, said cloth support device comprising a brassiere and being connected to and transmitting breast tissue weight to a top portion of a frame, said frame forming a walker and comprising: a top portion, at least three support struts extending downward from the top portion of the frame to the bottom portion of the frame, and at least two wheels connected to the bottom portion of the frame, said wheels being arranged to permit the walker to roll along a surface;
the patient taking at least one step forward while the breast tissue is supported by the cloth support device attached to the top portion of the frame.

57. The method of claim 56 further comprising the step of adjusting the height of the cloth support device with a mechanical lifting mechanism.

58. A mobile medical device comprising:
a walker, said walker comprising:
a frame, said frame comprising: a top portion, a bottom portion, at least three support struts extending downward from the top portion of the frame to the bottom portion of the frame, and at least two wheels connected to the bottom portion of the frame and being arranged to permit the walker to roll along a surface;
a first support platform for bearing right breast tissue weight of a patient, and a second support platform for bearing left breast tissue weight of a patient, each of said support platforms attached to respective sides of the top portion of the frame.

59. The mobile medical device of claim 58 further comprising a first support device for evenly distributing right breast tissue and a second support device for evenly distributing left breast tissue, each support device transmitting breast tissue weight to a respective support platform.

60. The mobile medical device of claim 58 wherein:
the first support platform is attached to the top portion of the frame at a first height and the second support platform is attached to the top portion of the frame at a second height; and
the mobile medical device further comprises a first and second lifting mechanism for adjusting the height of each respective support platform.

61. The mobile medical device of claim 60 wherein the first height of the first support platform is the same as the second height of the second support platform.

62. The mobile medical device of claim 60 wherein the first height of the first support platform is different than the second height of the second support platform.

63. The mobile medical device of claim 59 wherein:
the first support platform is attached to the top portion of the frame at a first height and the second support platform is attached to the top portion of the frame at a second height; and
the mobile medical device further comprises a first and second lifting mechanism for adjusting the height of each respective support platform.

64. The mobile medical device of claim 63 wherein the first height of the first support platform is the same as the second height of the second support platform.

65. The mobile medical device of claim 63 wherein the first height of the first support platform is different than the second height of the second support platform.

66. A mobile medical device comprising:
a walker, said walker comprising:
a frame, said frame comprising: a top portion, a bottom portion, at least three support struts extending downward from the top portion of the frame to the bottom portion of the frame, and at least two wheels connected to the bottom portion of the frame and being arranged to permit the walker to roll along a surface;
a first cloth support device for evenly distributing right breast tissue and being connected to and transmitting right breast tissue weight to the top portion of the frame, and a second support device for evenly distributing left breast tissue and being connected to and transmitting left breast tissue weight to the top portion of the frame.
